(19) United States
(12) Patent Application Publication
(10) Pub. No.: US 2025/0337176 A1
(43) Pub. Date: Oct. 30, 2025

(54) ELECTRICAL CONNECTION DEVICE

(71) Applicants: TE Connectivity India Private Limited, Bangalore (IN); TE Connectivity Solutions GmbH, Schaffhausen (CH)

(72) Inventors: Angadi PRAVEEN, Bangalore (IN); Saurabh BISHT, Bangalore (IN); Philippe FRANCE, Chassieu (FR)

(21) Appl. No.: 19/194,223

(22) Filed: Apr. 30, 2025

(30) Foreign Application Priority Data
Apr. 30, 2024 (EP) 24305685.0

(51) Int. Cl. H01R 9/26

(52) U.S. Cl. CPC H01R 9/26

(57) ABSTRACT

An electrical connection device for electrically connecting a plurality of electrical conductors. The electrical connection device comprises a distribution connector, the distribution connector comprising a first receptacle, a second receptacle, and at least one third receptacle. The first receptacle and the second receptacle each are configured to receive a respective conductor bar, in particular high-current conductor bar, through a respective first and second opening in the distribution connector. The third receptacle is configured to receive a wire through a third opening. The electrical connection device is characterized in that the first opening is round and the second opening is polygonal. The invention relates to a distribution connector for a power distribution block.

### CROSS REFERENCE TO RELATED APPLICATIONS

This application claims the benefit of EP Application No. 24305685.0, filed 30 Apr. 2024, the subject matter of which is herein incorporated by reference in its entirety.

### BACKGROUND OF THE INVENTION

The present invention relates to an electrical connection device for electrically connecting a plurality of electrical conductors.

Electrical connection devices are known in the art that electrically connect a plurality of electrical conductors via a distribution connector. These electrical connection devices are used in a variety of applications, for example in industrial or commercial buildings, in solar power installations (solar farms) or in wind power installations (wind farms). In some applications, an electrical connection device may be intended to distribute an incoming higher electrical current from a conductor bar to a plurality of outputs. In other applications, an electrical connection device may be intended bundle a plurality of incoming lower electrical currents to a single output conductor bar.

The configuration of the conductor bar may greatly vary in shape and size in accordance with the specifics of the application. In particular, even within a specific application, the shape and size of the conductor bar to be used may fluctuate in accordance momentary need and/or availability.

### BRIEF DESCRIPTION OF THE INVENTION

It is therefore an objective of the subject matter herein to provide an electrical connection device having improved flexibility of use while at the same time being more cost-efficient to manufacture.

This objective is achieved by means of an electrical connection device for electrically connecting a plurality of electrical conductors, the electrical connection device comprising a distribution connector, the distribution connector comprising a first receptacle, a second receptacle, and at least one third receptacle, the first receptacle and the second receptacle each being configured to receive a respective conductor bar, in particular high-current conductor bar, through a respective first and second opening in the distribution connector, and the third receptacle being configured to receive a wire through a third opening. According to an embodiment, the electrical connection device is characterised in that the first opening is round and the second opening is polygonal.

As this electrical connection device can connect a first conductor bar and a second conductor having different geometric configurations, in particular a conductor bar in a round configuration and a conductor bar in a polygonal, in particular rectangular, configuration. Thus, either one of different types of conductors bars can be connected to the electrical connection device, and the electrical connection device can be used in a greater number of applications, without requiring additional devices, tools or conditions. For example, the same electrical connection device can still be used unchanged, even if a change in the electrical installation requires a change in type of conductor bar, reducing the maintenance and installation costs. In addition, this electrical connection device allows for the connection of a plurality of conductor bars of different types at the same time, for example for a jumpering, that is, shorting of the distribution connector with further electrical connection devices.

In some aspects, the first receptacle can be configured to receive a first conductor bar having a round, in particular circular, transverse cross-section. In particular, the first opening can have a round, in particular circular, shape configured to mate the round, in particular circular, transverse cross-section of the first conductor bar. Accordingly, the electrical connection device can have improved suitability for connection with a conductor bar having a round transverse cross-section.

In some aspects, the second receptacle can be configured to receive a second conductor bar having a rectangular transverse cross-section. In particular, the second opening can have a rectangular shape configured to mate the rectangular transverse cross-section of the first conductor bar. Accordingly, the electrical connection device can have improved suitability for connection with a conductor bar having a rectangular transverse cross-section.

In some aspects, the first receptacle and the second receptacle can be configured to receive respective conductor bars along parallel conductor directions. This facilitates the exchange or addition of the conductor bar to be connected to the electrical connection device.

In some aspects, the third receptacle can be configured to receive a wire along a direction opposed to the parallel conductor directions. This arrangement allows for inlet conductors and outlet conductors on the connector to be advantageously separated, reducing the risk of errors and accidents in the installation.

In some aspects, the distribution connector can comprise a first surface that is transverse, in particular orthogonal, to the conductor directions, and a second surface that is transverse, in particular orthogonal, to the conductor directions, wherein the first opening is arranged in the first surface and the second opening is arranged in the second surface, and wherein the surfaces extend parallelly and are offset with respect to the parallel conductor directions.

Thus, when the conductors are fastened by orthogonally applied fasteners, for example grub screws, the offset of the surfaces in which the openings are arranged allows for a size reduction of the distribution connector. Specifically, by off-setting the surfaces, the length and/or width of the at least one of first and second receptacle can be reduced. The reduction in size can improve the distribution connector's handling and manufacturing costs.

In some aspects, the second receptacle can be arranged in between the first receptacle and the third receptacle with respect to the conductor directions. In this configuration, the receptacles are arranged at staggered positions along the conductor directions, and the fastening of each received electrical conductor or conductor bar in a respective receptacle is facilitated.

In some aspects, the third opening can have an area smaller than the area of the first opening and smaller than the area of the second opening. Thus, a conductor bar received in the first or second receptacle of the electrical connection device can be connected to an electrical wire.

In some aspects, the distribution connector can be a monolithic piece. A distribution connector in one monolithic piece can have at the same time greater durability and greater manufacturing cost-efficiency.

In some aspects, the distribution connector can be formed, in particular machined, from an electrically conductive material, preferably a copper alloy or a brass or an aluminium alloy or a zinc alloy such as zamak. Accordingly, the electrical connection from one conductor, for example a first conductor bar fastened in the first receptacle, to another electrical conductor, for example an electrical wire fastened in the third receptacle, is realized directly by the electrical conduction of the distribution connector itself.

In some aspects, the electrical connection device can further comprise a housing, the housing comprising, for each one of the first and second receptacle, a corresponding first and second weakened portion configured as a knock-out element, wherein the distribution connector is arranged in the housing such that each one of the first and second receptacle respectively faces the corresponding weakened portion.

Accordingly, the weakened portions can be removed so as to free an opening in the housing for the insertion of an electrical conductor into the distribution connector. Specifically, the realisation of a weakened portion instead of an opening improves the ingress protection (IP) of the electrical connection device to contamination, increasing its reliability. The IP factor of the electrical connection device specifically increases when only one conductor bar is connected to the electrical connection device, and thus only one weakened portion is removed.

In some aspects, at least one, preferably each, of the weakened portions configured as a knock-out element can comprise a traversing perforation configured to facilitate said knock-out element's removal from its respective weakened area. The traversing perforation allows for a corresponding tool to be inserted and realize an outward removal of the knock-out element from its respective weakened area.

In some aspects, the housing can comprise a conductor insertion side, wherein each of the first and the second weakened portion is arranged in the conductor insertion side, and wherein the conductor insertion side comprises a first and a second collar-shaped protrusion each respectively surrounding a corresponding weakened portion and protruding outwardly from the housing. The collar-shaped protrusion can facilitate guiding of a conductor bar in the distribution connector, reduce damage to the conductor bar from sharp edges, and additionally reduces the risk of accidental loosening of a weakened portion from careless handling.

In some aspects, the electrical connection device further comprises a supplementary protrusion protruding outwardly from the housing and connecting the first collar-shaped protrusion and the second collar-shaped protrusion. This supplementary connecting protrusion can increase the overall structural stability of the conductor insertion side and specifically of the collar-shaped protrusion formed thereon.

The subject matter herein also relates to a distribution connector for an electrical connection device, in particular for a power distribution block, according to any one of the above aspect. The distribution connector comprises a first receptacle, a second receptacle, and a third receptacle, the first receptacle and the second receptacle each being configured to receive a respective conductor bar, in particular a high-current conductor bar, through a respective first and second opening in the distribution connector, and the third receptacle being configured to receive a wire through a third opening, wherein the first opening is round and the second opening is polygonal. This distribution connector can contribute to the above-outlined advantages of the electrical connection device.

### BRIEF DESCRIPTION OF THE DRAWINGS

The above-described aspects, objects, features and advantages of the present invention will be more completely understood and appreciated by careful study of the following more detailed description of a presently preferred exemplary embodiment of the invention, taken in conjunction with accompanying drawings, in which:

FIG. 1 shows a first perspective view of an assembled and rail-mounted electrical connection device according to a first embodiment.

FIG. 2 shows a second perspective view of the electrical connection device.

FIG. 3 shows an exploded view of the electrical connection device.

FIG. 4 shows a perspective view of the distribution connector of the electrical connection device.

FIG. 5 shows a plane front view of the distribution connector.

FIG. 6 shows a plane front view of the electrical connection device.

### DETAILED DESCRIPTION OF THE INVENTION

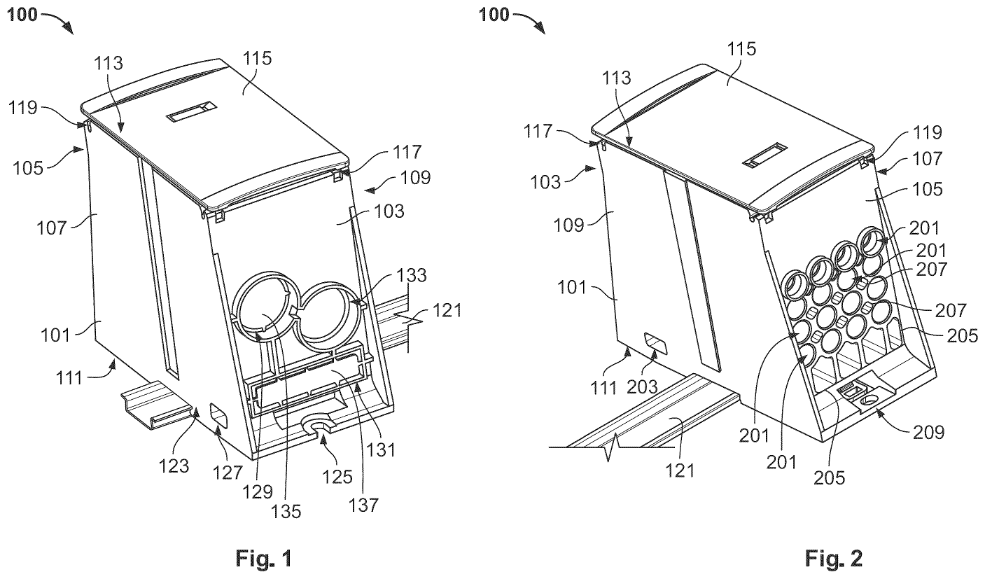

Unless explicitly described otherwise, the structural features of the objects illustrated in FIGS. 1 to 6 are not drawn to scale, neither individually with respect to their Cartesian dimensions, nor with respect to each other along one Cartesian direction. Further, in the following descriptions of FIGS. 1 to 6, identical reference signs used in different figures relate to identical elements.

The technical features and their associated advantages or effects described in the following can be combined with or adapted to any aspects or embodiments of the invention, together or independently, yielding further possible embodiments or aspects of the invention.

A first embodiment of the inventive electrical connection device is described with reference to FIGS. 1 through 6. The electrical connection device 100 of the first embodiment, shown in FIG. 1 in a perspective view, is configured as power distribution block for an industrial machining facility or a solar power electrical installation.

The electrical connection device 100 comprises a substantially cuboid housing 101 having a conductor insertion side 103 and a wiring side 105 opposed to the conductor insertion side 103, a first lateral side 107 connecting the conductor insertion side 103 with wiring side 105, and a second lateral side 109 connecting the conductor insertion side 103 with the wiring side 105. The housing 101 also comprises a backside 111, not visible on FIG. 1.

On a side opposed to the backside 111, the housing 101 comprises a housing opening 113 providing visual and manual access to the interior of the housing 101, for example for the fastening of fasteners, for example grub screws, through the housing opening 113. The electrical connection device 100 further comprises a cover 115 configured to cover the housing opening 113. The cover 115 is arranged with the housing 101 such that it movably covers and/or uncovers the housing opening 113.

Here, the cover 115 is arranged with the housing 101 by means of a double-hinge arrangement comprising a first hinge device 117 at the conductor insertion side 103, and a second hinge device 119 at the wiring side 105. The first hinge device 117 and the second hinge device 119 allow at the same time a reliable press fitting of the cover 115 with the housing 101, as well as an opening of the housing opening 113 by pivoting the cover 115 around either one of the hinge devices 117, 119 by dislodging the respective other one of the hinge devices 117, 119.

This specific configuration of the cover 115 allows for an opening of the housing opening 113 in two directions, increasing the flexibility of the mounting and maintenance of the electrical connection device 100.

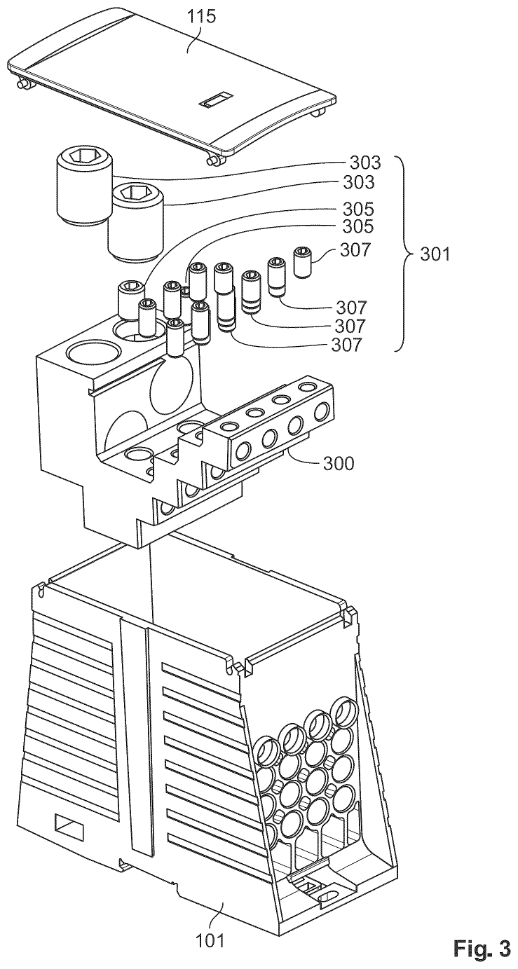

In variants, the electrical connection device may comprise a differently attached cover 115, or no cover at all. In other variants, the electrical connection device may not comprise any housing at all and may instead correspond to the unhoused components described with reference to FIG. 3.

FIG. 1 shows the electrical connection device 100 in a rail-mounted state, that is, in a state mounted to a mounting rail 121. Specifically, the backside 111 of the housing 101 comprises a rail-fitting device 123 configured of the fitting of the electrical connection device 100 to the mounting rail 121, and the mounting rail 121 is fit with the rail-fitting device 123. The rail 121 can be part of an electrical panel for an electrical installation.

The backside 111 of the housing 101 comprises a screw-fitting device 125 for an alternative or additional fitting of the electrical connection device 100 to a wall or a panel by means of a screw-fitting. Further, as shown on FIG. 1, the first lateral side 107 comprises a first lateral excavation 127 for reducing weight and material costs of the housing.

The conductor insertion side 103 of the housing 101 comprises at least two, here three, weakened portions 129, 131, 133. The weakened portions 129, 131, 133 are positioned in the conductor insertion side 103 such that their positions match respective openings in a distribution connector of the electrical connection device 100, to be described in the following. The weakened portions 1129, 131, 133 are partially perforated zones in the conductor insertion side 103 of the housing 101, wherein the perforations of each weakened portion 129, 131, 133 delimits a respective knock-out elements 135, 137.

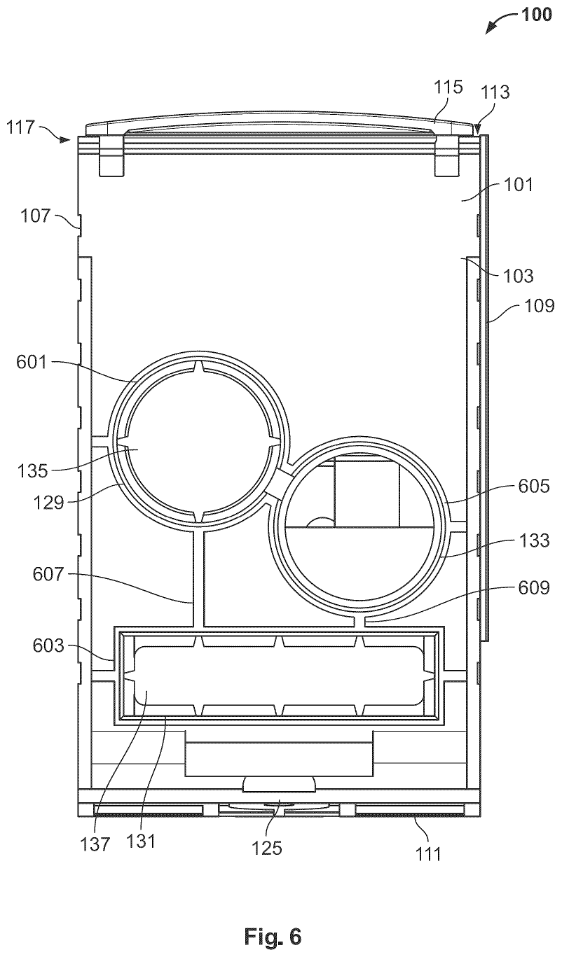

A knock-out element 135, 137 is a housing portion configured to be knocked-out, that is manually removed, should one of the corresponding openings of the distribution connector be needed for electrical connection of an electrical conductor. For illustration purposes, on FIG. 1, the first and the second knock-out element 129, 131 are shown as in place, that is, are visible, while the third knock-out element of the weakened portion 133 is removed. Further structural details with respect to the weakened portions 129, 131, 133 and the conductor insertion side 105 shall be described with respect to FIG. 6.

FIG. 2 shows another perspective view of the electrical connection device 100, in which the electrical connection device 100 is shown from the wiring side 105 opposed to the conductor insertion side 103. As shown on FIG. 2, the wiring side 105 comprises a plurality, here sixteen (16), insertion openings 201. The insertion openings 201 are arranged in a four-by-four (4×4) grid substantially centrally in the wiring side 105. The sixteen insertion openings 201 are positioned in the wiring side 105 such that their positions match respective openings in a distribution connector of the electrical connection device 100, to be described in the following. Thus, each insertion opening 201 is configured for an insertion of a respective electrical wire in the distribution connector.

FIG. 2 shows that the housing 101 comprises further material excavations to reduce weight and cost of the electrical connection device 100. Specifically, the housing 101 comprises a second lateral excavation 203 in the second lateral side 109 in a position opposed to the first lateral excavation 127, a plurality of larger excavations 205 that are provided in the wiring side 105 between the 4×4 grid of insertion openings 201 and the backside 111, and a plurality of smaller excavations 207 that are provided inside the grid of insertion openings 129, at the grid intersections.

Further excavations may be provided for, in order to reduce mass, improve manufacturing and/or improve visual access. For example, in some variants, a portion of the first connection 103 side of the housing 101 between the weakened area 131 and the bottom surface 111 may be partially or entirely excavated.

On the wiring side 105, the housing 101 comprises a second screw-fitting device 209 in a position opposed to the first screw-fitting device 125. The second screw-fitting device 209 is also configured for an alternative or additional fitting of the electrical connection device 100 to a wall or a panel by means of a screw-fitting.

FIG. 3 shows the electrical connection device 100 in an exploded view. In addition to the housing 101 and the cover 115 already described in the preceding, the electrical connection device 100 comprises a distribution connector 300 and a plurality of fasteners 301.

The present electrical connection device 100 of the first embodiment is a power distribution block configured for electrical currents of 50 A to 1500 A, preferably 100 A to 900 A. Specifically, the electrical connection device 100 is configured to electrically connect up to three (3) conductor bars conductors, specifically rigid high-current conductor busbars, with up to sixteen (16) electrical wires. Each one of the plurality of fasteners 301 is configured to fasten a respective one of the three conductor bars and/or the sixteen electrical wires with the distribution connector, when the respective electrical conductor is received in a respective receptacle of the distribution connector 300.

In detail, in the present embodiment, the plurality of fasteners 301 consists of two round busbar fasteners 303 for the respective fastening of up to two respective round busbars, two rectangular busbar fasteners 305 for the fastening of up to one rectangular busbar, and sixteen electrical wire fasteners 307 for the respective fastening of up to sixteen respective electrical wires. The fasteners 303 are headless bolts, specifically grub screws or blind screws, having external threads configured to grip with respective internal threads of respective receptacles in the distribution connector 300. Each fastener 301, 303, 305, 307 is configured to fasten and secure a respective electrical conductor with the distribution connector 300 by orthogonally applying a pressure on an electrical conductor against an internal surface of the distribution connector 300.

The housing 101, the distribution connector 300, and each one of the fasteners 301 is a separate piece, wherein the distribution connector 300 and each one of the fasteners 303 are assembled together in the housing 101.

The distribution connector 300 is a monolithic piece machined from a metallic block, here from a zinc alloy, preferably zamak. Alternatively, the distribution connector 300 can be formed from a copper alloy or a brass or an aluminium alloy.

The fasteners 301 are formed are also each machined in one piece from an electrically conductive material, here a steel. Alternatively, the fasteners 301 may be formed from a same material as the distribution connector 300.

The housing 101 and the cover 115 are preferably formed in an insulating thermoplastic polymer, for example an acrylonitrile butadiene styrene (ABS) or a polybutylene terephthalate (PBT) or a polyketone (PK) or a polycarbonate (PC) or a polyamide (PA) such as PA66.

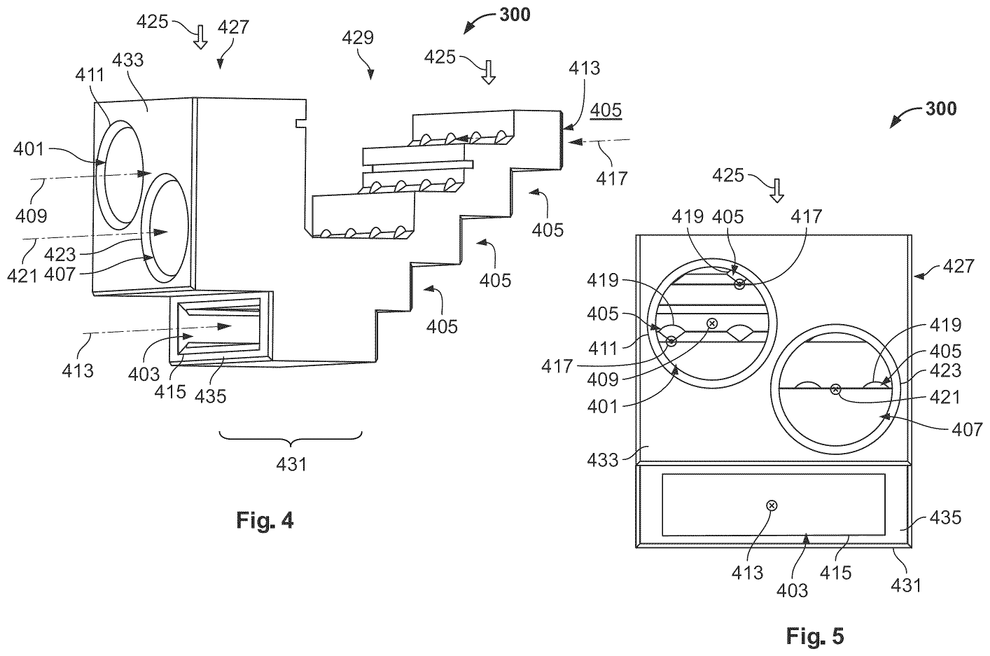

The distribution connector 300 will now be described with reference to FIG. 4 together with FIG. 5. The distribution 300 part of the electrical connection device 100 of the first embodiment is also a distribution connector according to a second embodiment.

FIG. 4 shows a perspective view of the distribution connector 300. The distribution connector 300 comprises a plurality of receptacles. Specifically, the distribution connector 300 comprises a first receptacle 401, a second receptacle 403, a plurality of third receptacles 405, and a supplementary receptacle 407.

The first receptacle 401 is configured to receive a first conductor bar that is inserted, in a first conductor direction 409, through a first opening 411 in the distribution connector 300. Specifically, the first receptacle 401 is configured to receive a first conductor bar having a circular transverse cross-section, and the first opening 411 is also a circular. That is, the first opening 411 has a circular shape configured to mate the circular transverse cross-section of the first conductor bar to be received in the first receptacle 401.

In variants of this embodiment, however, the first conductor bar to be received in the first receptacle may have a round transverse cross-section different from circular, for example an elliptical or an egg-shaped transverse section, and correspondingly, the first opening is also elliptical or egg-shaped, and the first receptacle is respectively shaped to receive the round non-circular first conductor bar.

In variants of this embodiment, the first receptacle 401 is also configured to receive a first conductor that is not a bar, such as a high-current busbar, but instead a conductor cable, in particular a high-current conductor cable. Accordingly, each busbar fasteners 303 can also be configured to fasten a conductor cable, instead of a conductor bar.

The second receptacle 403 is configured to receive a second conductor bar that is inserted, in a second conductor direction 413, through a second opening 415 in the distribution connector 300. Specifically the second receptacle 403 is configured to receive a second conductor bar having a rectangular transverse cross-section, and the second opening 415 is also correspondingly rectangular. That is, the second opening 415 has a rectangular shape configured to mate the rectangular transverse cross-section of the second conductor bar to be received in the second receptacle 403.

In variants of this embodiment, however, the second conductor bar to be received in the second receptacle may have a polygonal transverse cross-section different from rectangular, for example a triangular or a T-shaped transverse section, and correspondingly, the first opening is also triangular or T-shaped, and the second receptacle is respectively shaped to receive the polygonal non-rectangular second conductor bar.

Each one of the plurality of third receptacles 405, here sixteen third receptacles 405, is configured to receive a respective electrical wire inserted, in a respective third conductor direction 417, through a respective third opening 419 in the distribution connector 300. Accordingly, each one of the third openings is 419 has an area smaller than the area of each one of the first opening 411, the second opening 415 and the supplementary opening 423.

The optional supplementary receptacle 407 is identical to the first receptacle 401 and configured to receive, in a supplementary conductor direction 421, a supplementary round conductor bar through a supplementary opening 423.

In the present embodiment, the first conductor direction 409, the second conductor direction 413, each one of the respective third conductor directions 417 and the supplementary conductor direction 421 are parallel to each other. However, each one of the respective third conductor directions 417 is also directed opposed to each one of the first conductor direction 409, the second conductor direction 413 and the supplementary conductor direction 421.

The first conductor bar, the second conductor bar, and the supplementary round conductor bar may each correspond to an extremity of a high-current round busbar from which any insulating material has been removed. Similarly, the electrical wires received in the third receptacles 407 may correspond to the remaining conductive cores of insulation-stripped electrical wires.

Each one of the first receptacle 401, the second receptacle 403, the supplementary receptacle 407, and the third receptacles 405 additionally comprises a respective fastening opening. The fastening openings are not visible on FIG. 4 and FIG. 5, but visible on FIG. 3. The respective fastening openings are configured to receive the respective fasteners along respective parallel fastening directions 425 that are orthogonal to the conductor directions 409, 413, 417, 421. The respective fastening openings allow for a fastening of the electrical conductors received in the receptacles 401, 403, 407, 405. Specifically, a portion of the receptacles 401, 403, 407, 405 extending along the fastening direction 425 is internally threaded and configured to mesh with the external threading of a matching fastener 301.

As shown on FIG. 4, the first receptacle 401 and the supplementary receptacle 407 are arranged on a first side 427 of the distribution connector 300. On the other hand, each one of the third receptacles 405 is arranged on a second side of 429 the distribution connector 300 that is opposed to the first side 427. The second receptacle 403 is in the middle portion 431 of the distribution connector 300, the middle portion 431 being positioned between the first side 427 and the second side 429 of the distribution connector 300. Specifically, the second receptacle 403 configured for the receiving of a rectangular high-current busbar is arranged, with respect to each one of the conductor direction is 409, 413, 417, 421, in between in the first receptacle 401 and each one of the third receptacles 405.

The sixteen third receptacles 407 are arranged in four rows of four, wherein each row 433 is arranged along the conductor directions 409, 413, 417, 421 in a diagonally staggered, that is, shifted, position with respect to its neighbouring row 433. Similarly, the rectangularly shaped second receptacle 403 is arranged along the conductor direction is 409, 413, 417, 429 in a diagonally staggered, that is, shifted, position with respect to the first receptacle 401 and the supplementary receptacle 407. In other words, the first opening 411 is formed in a first transverse surface 433 of the distribution connector 300, and the second opening 415 is formed in a second transverse surface 435 of the distribution connector 300, wherein the first transverse surface 433 and the second transverse surface 135 orthogonally to the conductor directions 409, 413, 417, 429 and are offset with respect to the conductor directions 409, 413, 417, 429.

Due to the staggered arrangement of the receptacles 401, 403, 407, 405, the distribution connector 300 is formed substantially in a V-shape in the plane formed by the conductor direction 409, 413, 417, 421 and the fastening direction 425. Specifically, the first side 427 of the distribution connector 300 corresponds to a first limb of the V-shape and the second side 429 of the distribution connector 300 corresponds to a second limb of the V-shape. The staggered arrangement of the receptacles 401, 403, 407, 405, allows for improved access to each of the receptacles 400 for a fastening with a fastener 303, but also allows for reduction of manufacturing material of the distribution connector 300.

In some variants, the distribution connector 300 may comprise a voltage measurement device, in particular a hole suitable for voltage measurement. The hole can be configured to receive a voltage measurement sensing element or a voltage measuring test probe. Preferably, the voltage measurement device can be arranged in the middle portion 431. Preferably, the voltage measurement device can be arranged in the distribution connector 300 such that it is accessible through the housing opening 113 when the distribution connector 300 is arranged in the housing 101. The voltage measurement device may serve to verify the electric potential of the distribution connector 300, in particular to increase maintenance operation safety.

FIG. 6 shows a plane front view of the electrical connection device 100, illustrating the conductor insertion side 103 of the housing 101, as well as the cover 115. The distribution connector 300 is arranged inside the housing 101 such that the first side 427 is closer to the conductor insertion side 103, and the second side 429 is closer to the wiring side 105. Specifically, the distribution connector 300 is arranged inside the housing 101 such that the first transverse surface 433 faces the internal surface of the conductor insertion side 103 with no or minimal clearance.

As previously described, the conductor insertion side 103 comprises the first weakened portion 129, the second weakened portion 131, and the third weakened portion 133. The first weakened portion 129 corresponds to a perforated zone of the conductor insertion side 103 perforated so as to delimit the first, here circularly shaped, knock-out element 135, and the second weakened portion 131 corresponds to a perforated zone of the conductor insertion side 103 perforated so as to delimit the second, here rectangularly shaped, knock-out element 137.

For illustration purposes, the conductor insertion side 103 is shown in FIG. 6 in a state in which the third weakened portion 133 is further loosened, such that the therein delimited knock-out element is removed. Thus, it is possible to view into the housing 101, in which are arranged the distribution connector 300, and, for example here, a rectangular busbar fastener 305 which is pre-fastened with a corresponding opening of the second receptacle 403.

The first weakened portion 129 and the first knock-out element 135 are arranged in the conductor insertion side 103 so as to face, that is, match the position of the first opening 411. Similarly, the second weakened portion 131 and the second knock-out element 137 are arranged in the conductor insertion side 103 so as to face, that is, match the position of the second opening 415. In addition, the third weakened portion 133 and the third knock-out element (removed in FIG. 6) are arranged in the conductor insertion side 103 so as to face, that is, match the position of the supplementary opening 423.

In some variants, one or more of the knock-out elements 135, 137 can additionally be provided with a traversing perforation to facilitate said knock-out element's 135, 137 removal from its respective weakened area 129, 131, 133. For example, one or more of the knock-out elements 135, 137 may comprise a traversing perforation in a specific shape, such that a corresponding tool can be inserted and realize an outward removal of the knock-out element 135, 137 from its respective weakened area 129, 131, 133.

The conductor insertion side 103 further comprises a first collar-shaped protrusion 601 surrounding the weakened portion 129, a second collar-shaped protrusion 603 surrounding the weakened portion 131, and a third colour-shaped protrusion 605 surrounding the weakened portion 133. Each one of the first, second, and third collar-shaped protrusion 601, 603, 605 protrudes outwardly from the housing 101. Specifically, the protrusions 601, 603, 605, each delineate the outline of their respectively surrounding weakened portion 129, 131, 133, and each protrude orthogonally from the conductor insertion side 103.

The second, rectangular collar-shaped protrusions 603 is connected to the first, round collar-shaped protrusion 601 by means of a first supplementary protrusion 607, and also connected to the third, round collar-shaped protrusion 605 by means of a second supplementary protrusion 609. The first and the second supplementary protrusions 607, 609 also protrude outwardly from the housing 101 orthogonally to the conductor insertion side 103 and serve to structurally strengthen the collar-shaped protrusions 601, 603, 605.

The electrical connection device 100 of the first embodiment and the distribution connector 300 of the second embodiment provide increased flexibility of connections. For example, an electrical installation may choose to change a connection from a circular busbar to a rectangular busbar without being required to also exchange the electrical connection device.

Alternatively or in addition, the electrical connection device 100 can be short-circuited with further electrical devices via a unused one of the receptacles 401, 403, 403. For example, an electrical installation may choose to connect a rectangular busbar to the electrical connection device 100 via the rectangular receptacle 403, and then short-circuit a second electrical connection device via the round receptacle 401 and/or short-circuit a third electrical connection device via the round receptacle 405. In another example, the electrical installation may choose to connect a round cable to the electrical connection device 100 via the round receptacle 401 resp. 405, and then short-circuit a second electrical connection device via rectangular receptacle 403 and/or short-circuit a third electrical connection device via the round receptacle 405 resp. 401

Thus, the electrical connection device 100 of the first embodiment and the distribution connector 300 of the second embodiment are applicable in a greater variety of possible applications. At the same time, as outlined in the preceding description, the manufacturing costs are maintained low or even reduced.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical connection device for electrically connecting a plurality of electrical conductors including conductor bars and a wire, the electrical connection device comprising:
a distribution connector comprising a first receptacle, a second receptacle, and at least one third receptacle;
the first receptacle configured to receive a respective conductor bar through a respective first opening in the distribution connector;
the second receptacle configured to receive a respective conductor bar through a respective second opening in the distribution connector;
the third receptacle being configured to receive a wire through a third opening;
wherein the first opening is round and the second opening is polygonal.

2. Electrical connection device according to claim 1, wherein the first receptacle is configured to receive a first conductor bar having a round transverse cross-section.

3. Electrical connection device according to claim 2, wherein the first opening has a round shape configured to mate the round transverse cross-section of the first conductor bar.

4. Electrical connection device according to claim 1, wherein the second receptacle is configured to receive a second conductor bar having a rectangular transverse cross-section.

5. Electrical connection device according to claim 4, wherein the second opening has a rectangular shape configured to mate the rectangular transverse cross-section of the second conductor bar.

6. Electrical connection device according to claim 1, wherein the first receptacle and the second receptacle are configured to receive respective conductor bars along parallel conductor directions.

7. Electrical connection device according to claim 6, wherein the third receptacle is configured to receive a wire along a direction opposed to the parallel conductor directions.

8. Electrical connection device according to claim 6, wherein the distribution connector comprises a first surface transverse to the conductor directions and second surface transverse to the conductor directions, wherein the first opening is arranged in the first surface and the second opening is arranged in the second surface, and wherein said first and second openings extend parallelly and are offset with respect to the parallel conductor directions.

9. Electrical connection device according to claim 6, wherein the distribution connector comprises a first surface orthogonal to the conductor directions and second surface orthogonal to the conductor directions, wherein the first opening is arranged in the first surface and the second opening is arranged in the second surface, and wherein said first and second openings extend parallelly and are offset with respect to the parallel conductor directions.

10. Electrical connection device according to claim 6, wherein the second receptacle is arranged in between the first receptacle and the third receptacle with respect to the conductor directions.

11. Electrical connection device according to claim 1, wherein the distribution connector is a monolithic piece.

12. Electrical connection device according to claim 11, wherein the distribution connector is formed from an electrically conductive material comprising at least one of a copper alloy or a brass or an aluminum alloy or a zinc alloy such as zamak.

13. Electrical connection device according to claim 1, further comprising a housing, the housing comprising, for each one of the first and second receptacle, a corresponding first and second weakened portion configured as a knock-out element, wherein the distribution connector is arranged in the housing such that each one of the first and second receptacle respectively faces the corresponding weakened portion.

14. Electrical connection device according to claim 13, wherein the housing comprises a conductor insertion side, wherein each of the first and the second weakened portion is arranged in the conductor insertion side, and wherein the conductor insertion side comprises a first and a second collar-shaped protrusion each respectively surrounding a corresponding weakened portion and protruding outwardly from the housing.

15. Electrical connection device according to claim 14, comprising a supplementary protrusion protruding outwardly from the housing and connecting the first collar-shaped protrusion and the second collar-shaped protrusion.

16. Electrical connection device for electrically connecting a plurality of electrical conductors including conductor bars and a wire, the electrical connection device comprising:
a distribution connector comprising a first receptacle, a second receptacle, and at least one third receptacle, the first receptacle configured to receive a respective conductor bar through a respective first opening in the distribution connector, the second receptacle configured to receive a respective conductor bar through a respective second opening in the distribution connector, the third receptacle being configured to receive a wire through a third opening, wherein the first opening is round and the second opening is polygonal; and
a housing comprising, for each one of the first and second receptacle, a corresponding first and second weakened portion configured as a knock-out element;
wherein the distribution connector is arranged in the housing such that each one of the first and second receptacle respectively faces the corresponding weakened portion.

17. Electrical connection device according to claim 16, wherein the housing comprises a conductor insertion side, wherein each of the first and the second weakened portion is arranged in the conductor insertion side, and wherein the conductor insertion side comprises a first and a second collar-shaped protrusion each respectively surrounding a corresponding weakened portion and protruding outwardly from the housing.

18. Electrical connection device according to claim 17, comprising a supplementary protrusion protruding outwardly from the housing and connecting the first collar-shaped protrusion and the second collar-shaped protrusion.

19. Distribution connector for a power distribution block, the distribution connector comprising:
a first receptacle, a second receptacle, and at least one third receptacle;
the first receptacle configured to receive a respective conductor bar through a respective first opening in the distribution connector;
the second receptacle configured to receive a respective conductor bar through a respective second opening in the distribution connector;
the third receptacle being configured to receive a wire through a third opening;
wherein the first opening is round and the second opening is polygonal.
